(19) United States
(12) Patent Application Publication
(10) Pub. No.: US 2015/0054185 A1
(43) Pub. Date: Feb. 26, 2015

(54) Method for Producing Wafer Lens

(71) Applicant: Daisuke Watanabe, Tokyo (JP)

(72) Inventor: Daisuke Watanabe, Tokyo (JP)

(21) Appl. No.: 14/280,881

(22) Filed: May 19, 2014

Related U.S. Application Data
(62) Division of application No. 12/933,085, filed on Sep. 16, 2010, now abandoned.

(30) Foreign Application Priority Data
Mar. 19, 2008 (JP) 2008-072031

(51) Int. Cl. B29C 39/12; B29D 11/00

(52) U.S. Cl. CPC B29C 39/123; B29D 11/00307; B29K 2063/00
USPC 264/1.7

(57) ABSTRACT

Disclosed is a method for producing a wafer lens wherein a glass substrate is provided with a lens part which is made of a first curable resin. A sub-master molding part having a plurality of negative molding surfaces corresponding to the optical surface shape of the lens part is formed from a master having a plurality of positive molding surfaces corresponding to the optical surface shape of the lens part by using a second curable resin; a sub-master is formed by backing the sub-master molding part with a sub-master substrate; and the lens part is formed by filling the space between the sub-master and the glass substrate with the first curable resin and curing the resin therein. In this connection, the first curable resin is composed of an epoxy resin. Consequently, the production cost can be reduced, and a high-precision wafer lens having small curing shrinkage can be produced.

### CROSS-REFERENCE OF RELATED APPLICATIONS

This is a divisional application of U.S. patent application Ser. No. 12/933,085, filed on Sep. 16, 2010, which is a U.S. National Phase under 35 U.S.C. §371 of International Application No. PCT/JP2009/054748, filed on Mar. 12, 2009, which in turn claims the priority of Japanese Patent Application No. 2008-072031, filed on Mar. 19, 2008, each of which is hereby incorporated herein in its entirety by reference.

### FIELD OF INVENTION

The present invention relates to a method for producing a wafer lens.

### DESCRIPTION OF THE RELATED ART

In the field of producing an optical lens, studies have been made to develop a technique of obtaining an optical lens of high heat resistance by providing a glass plate with a lens part (optical member) made of a curable resin such as a thermoplastic resin (Patent Literature 1).

One of the methods for manufacturing an optical lens using this technique developed so far is the method for simultaneous molding of a plurality of lenses integrated with one another, by forming a so-called “wafer lens” wherein a glass plate is provided with a plurality of the optical member made of a curable resin, and the glass plate is cut off after molding. This production method cuts off the optical lens production cost.
Patent Literature 1: Japanese Patent No. 3926380

### DISCLOSURE OF THE INVENTION

### Problems to be Solved by the Invention

However, the specific molding method or production method is not described in the Patent Literature 1. Thus, an optical lens cannot be manufactured.

It would be possible to produce a negative mold corresponding to the lens part, and to perform molding operation. However, this will require a high level of precision, and the mold must be replaced whenever the mold is deteriorated by repeated use. This will raise the running cost of the production apparatus, and hence the optical lens production cost.

A high molding precision is required to produce the lens part. This, in turn, requires small curing shrinkage and high dimensional stability.

In view of the problems described above, it is an object of the present invention is to provide a method for producing a wafer lens wherein a wafer lens characterized by small curing shrinkage and high precision can be produced at a reduced production cost.

### Means for Solving the Problems

To solve the aforementioned problems, the present invention provides a method for producing a wafer lens in which an optical member made of a photocurable first hardening resin is provided on a glass substrate, is characterized by comprising: molding a sub master molding part having a plurality of molding surfaces with a negative configuration corresponding to an optical surface configuration of the optical member by using a transparent second hardening resin, from a master mold having a plurality of molding surfaces with a positive configuration corresponding to the optical surface configuration of the optical member; fabricating a sub master mold by lining the sub master molding part with a transparent sub master substrate made of glass, thereby; and filling a space between the sub master mold and the substrate with the first hardening resin and hardening the first hardening resin by providing irradiation from a side of the sub master mold, thereby molding the optical member, wherein the first hardening resin is composed of an epoxy resin.

### The Effect of Invention

In the present invention, the first curable resin is composed of an epoxy resin. This arrangement provides a high-precision wafer lens having small curing shrinkage.

The negative sub master mold is formed using the positive master mold corresponding to the optical surface shape of the optical member, and the optical member is molded by the sub master mold. This reduces the deterioration of the master mold when the master mold is repeatedly molded, as compared to the cases wherein the optical member is molded directly from the master mold. Thus, the running cost of the production apparatus and hence the optical lens production cost can be reduced by the amount equivalent to the reduction in the master mold reproduction cost.

When the first curable resin is made of an actinic radiation curable resin, even if transmission of the actinic radiation of the resin material of the optical member is not allowed, for example, when the master mold is made of metal, the resin material can be irradiated with actinic radiation from the side opposite the substrate in the process of molding of the optical member, if the sub master mold is so arranged as to permit transmission of the actinic radiation. This ensures reliable curing of the optical member.

### BRIEF DESCRIPTION OF THE DRAWINGS

FIG. 1 is a perspective view showing the schematic configuration of a wafer lens;

FIG. 2 is a perspective view showing the schematic configuration of a master and a sub master;

FIGS. 3a-3f are diagrams representing how to produce a wafer lens;

FIG. 4 is a diagram showing the schematic configuration of a master, a sub master and a sub-sub master;

FIGS. 5a-5e are diagrams for explaining a producing method of a wafer lens;

FIGS. 6a-6b are diagrams representing how to produce a wafer lens wherein the succeeding portion of FIGS. 5a-5e is illustrated;

FIG. 7 is a plan view showing the schematic configuration of a large-diameter sub master;

FIG. 8 is a plan view showing the schematic configuration of a regular sub master;

FIG. 9 is a diagram schematically showing how to form a lens part on the front and rear sides of a glass substrate using a large-diameter sub master and a regular sub master;

FIG. 10 is an illustration for explaining inconvenience at the time of using a large-diameter sub master;

FIG. 11 is a diagram showing a variation of the large-diameter sub master; and

FIGS. 12a-12e are illustrations showing reactions between OH groups on a surface of a master and a mold releasing agent employing an alkoxy silane group as one example of a functional group which can hydrolyze at an end.

### EXPLANATION OF REFERENCE SYMBOLS

1. Wafer lens
3. Glass substrate
5. Lens part
5A. Resin
10 (10A, 10B) Master
12. Base part
14. Protruding section
16. Recessed section
20. Sub Master
22. Sub Master molding part
22A. Resin
24. Recessed section
25. Protruding section
26. Sub Master substrate
30. Sub Master
32. Sub Master molding section
32A. Resin
34. Protruding section
36. Sub Master substrate
40. Sub-sub Master
42. Sub-sub Master molding section
42A. Resin
44. Recessed section
46. Sub-sub Master substrate
50, 52, 54. Light source
60. Stretching allowance
200. Large-diameter Sub Master
210. Stress relaxing section

### BEST MODE FOR CARRYING OUT THE INVENTION

The following describes the preferred embodiment of the present invention with reference to drawings.

### Embodiment 1

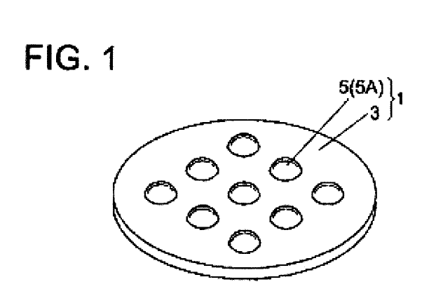

As shown in FIG. 1, the wafer lens 1 has a circular glass substrate 3 and a plurality of lens parts (optical member) 5. A plurality of lens parts 5 are arranged in an array on the glass substrate 3. The lens parts 5 can be formed on the surface of the glass substrate 3 or on the front and rear sides.

<Lens Part>

The lens part 5 is formed of a resin 5A (first curable resin). The epoxy-based curable resin can be used as the resin 5A. The curable resin can be broadly classified into a photocurable resin and thermosetting resin. The photocurable epoxy resin can be cured reaction through cationic polymerization, while the thermosetting resin can be cured by radical polymerization and cationic polymerization.

The following describes the details of resins.

(Epoxy Resin)

There is no particular restriction to the type of the epoxy resin if it includes an epoxy group and can be cured by polymerization through light or heat. Acid anhydride and cation generator can be used as a curing initiator. The epoxy resin is characterized by low curing shrinkage and is preferably used to produce a lens of excellent molding precision.

The types of epoxy include novolak phenolic epoxy, biphenyl epoxy resin, and dicyclopentadiene type epoxy resin. The examples thereof are bisphenol F diglycidylether, bisphenol A diglycidylether, 2,2′-bis(4-glycidyloxy cyclohexyl) propane, 3,4-epoxycyclohexylmethyl-3,4-epoxycyclohexane carboxylate, vinylcyclohexenedioxide, 2-(3,4-epoxycyclohexyl)-5,5-spiro-(3,4-epoxycyclohexane)-1,3-dioxane, bis(3,4-epoxycyclohexyl)adipate, and 1,2-cyclopropane dicarboxylate bisglycidyl ester.

The curing agent is used to produce a curable resin material without any particular restriction thereto. In the present invention, when comparison is made of the transmittances between the curable resin and the optical member after additives have been added, the curing agent is assumed not to include additives. An acid anhydride curing agent, phenol curing agent, and photo-cation initiator are preferably used as the curing agent. Specific examples of the acid anhydride curing agent include anhydrous phthalic acid, anhydrous maleic acid, anhydrous trimellitic acid, anhydrous pyrromellitic acid, hexahydro 3-methyl-hexahydro anhydrous phthalic acid, mixture between 4-methyl-hexahydro anhydrous phthalic acid or 3-methyl-hexahydro anhydrous phthalic acid and 4-methyl-hexahydro anhydrous phthalic acid, tetrahydro anhydrous phthalic acid, anhydrous nadic acid, and anhydrous methyl nadic acid. The photo-cation initiator is exemplified by onium salt, diazonium salt, iodonium salt, and sulfonium acetones. Further, a curing accelerating agent is included, as required. There is no particular restriction to the curing accelerating agent if satisfactory curability, resistance to coloring and transparency of thermosetting resin are ensured. The examples include imidazoles such as 2-ethyl-4-methylimidazole (2E4MZ), bicyclic amidines such as tertiary amine, quaternary ammonium salt, and diazabicycloundecen, derivatives thereof, phosphine, and phosphonium salt. One of them or a mixture of two or more can also be used.

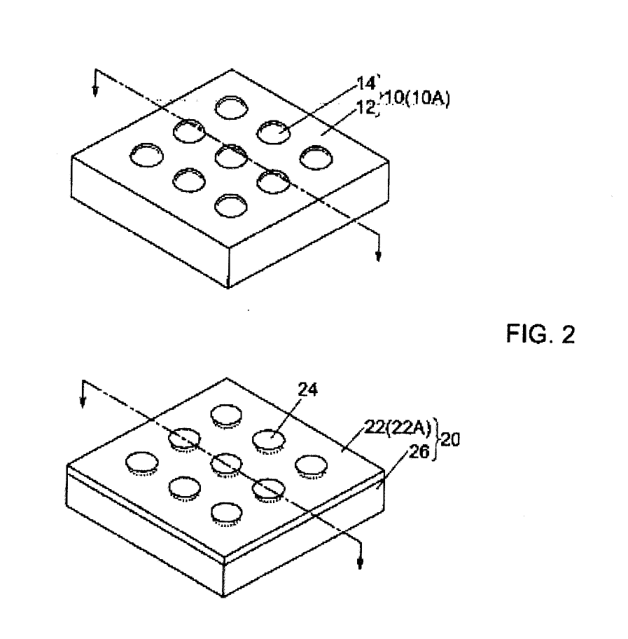

In the production of a wafer lens 1, a master mold (hereinafter referred to as “master” for short) 10 of FIG. 2 and a sub master mold (hereinafter referred to as “sub master” for short) 20 are used as molds.

<Master>

As shown in FIG. 2, the master 10 has a plurality of protruding sections 14 formed in array with respect to a rectangular parallelepiped base section 12. The protruding sections 14 are the positions corresponding to the lens part 5 of the wafer lens 1, and are protruded from the base part 12 in an approximately hemispherical form.

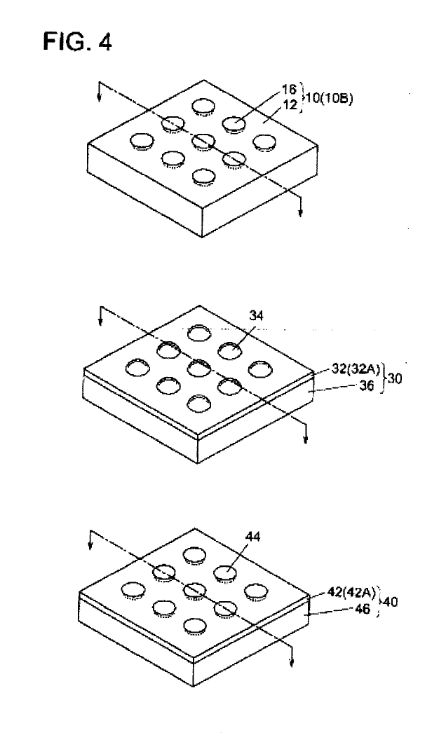

The optical surface shape of the master 10 (surface shape) may have a protruded shape with a protruding section 14 formed thereon, as shown in FIG. 2, or a recessed shape with a plurality of recessed sections 16 thereon, as shown in FIG. 4. In this case, the surface (molded surface) of the protruding section 14 and recessed section 16 is designed in a sponge configuration corresponding to the optical surface shape (shape of the surface opposite the glass substrate 3) molded and transferred on a glass substrate 3. In the following description, the master 10 of FIG. 2 will be called a master 10A and the master 10 of FIG. 4 will be called a master 10B to distinguish between them.

Metal or metallic glass can be used as a molding material of the master 10A. Materials can be classified as iron-based materials and other alloys. The iron-based materials include a hot working mold, cold working mold, plastic mold, high-speed tool steel, rolling steel product for general structure, carbon steel for mechanical structure, chromium/molybdenum steel, and stainless steel. Of these, the plastic molds are exemplified by pre-hardened steel, quenched/tempered steel and steel subjected to aging treatment. The pre-hardened steel is exemplified by SC-, SCM- and SUS-based steels. To put it more specifically, SC steels include PXZ, and SCM steels include HPM2, HPM7, PX5 and IMPAX. The SUS steels are exemplified by HPM38, HPM77, S-STAR G-STAR, STAVAX, RAMAX-S and PSL. The examples of steel-based alloys are found in the Japanese Unexamined Patent Application Publication No. 2005-13161 and Japanese Unexamined Patent Application Publication No. 2005-206913. The well-known examples of the major non-ferrous alloys are copper alloy, aluminum alloy and zinc alloy. Examples are alloys disclosed in the Japanese Unexamined Patent Application Publication No. Hei 10-219373 and Japanese Unexamined Patent Application Publication No. 2000-176970.

Glass can also be used as a material for molding the master 10A. Use of glass as a material for molding the master 10A provides an advantage of allowing transmission of ultraviolet rays. There is no particular restriction to the glass if it is commonly used glass.

The material for molding the master 10A can be exemplified by glass of low melting point, metallic glass and other similar materials which can easily become fluid at a low temperature. Use of glass of low melting point preferably allows a sample to be irradiated from the mold side thereof when the ultraviolet curable material is molded. Glass of low melting point refers to the glass having a glass-transition temperature of about 600° C. or less. One example is the glass with a glass composition of ZnO—PbO—B2O3, PbO—SiO2—B2O3, PbO—P2O5—SnF2. The examples of the glass that melts at a temperature of 400° C. or less are PbF2—SnF2—SnO—P2O5, and the substances having similar structures. Examples are S-FPL51, S-FPL53, S-FSL 5, S-BSL7, S-BSM2, S-BSM4, S-BSM9, S-BSM10, S-BSM14, S-BSM15, S-BSM16, S-BSM18, S-BSM22, S-BSM25, S-BSM28, S-BSM71, S-BSM81, S-NSL 3, S-NSL5, S-NSL36, S-BAL2, S-BAL3, S-BAL11, S-BAL12, S-BAL14, SBAL35, S-BAL41, S-BAL42, S-BAM3, S-BAM 4, S-BAM12, S-BAH10, S-BAH11, S-BAH27, S-BAH28, S-BAH32, S-PHM52, S-PHM53, S-TIL1, S-TIL2, S-TIL6, S-TIL25, S-TIL26, S-TIL27, S-TIM1, S-TIM2, S-TIM3, S-TIM5, S-TIM8, S-TIM22, S-T1M25, S-TIM27, S-TIM28, S-TIM35, S-TIM39, S-TIH1, S-TIH3, S-TIH4, S-TIH6, S-TIH10, S-TIH11, S-TIH13, S-TIH14, S-TIH18, S-TIH23, S-TIH53, S-LAL7, S-LAL8, S-LAL9, S-LAL10, S-LAL12, S-LAL13, S-LAL14, S-LAL18, S-LAL54, S-LAL56, S-LAL58, S-LAL59, S-LAL61, S-LAM2, S-LAM3, S-LAM 7, S-LAM51, S-LAM52, S-LAM54, S-LAM55, S-LAM58, S-LAM59, S-LAM60, S-LAM61, S-LAM66, S-LAH51, S-LAH52, S-LAH53, S-LAH55, S-LAH58, S-LAH59, S-LAH60, S-LAH63, S-LAH64, S-LAH65, S-LAH66, S-LAH71, S-LAH79, S-YGH51, S-FTM16, S-NBM51, S-NBH5, S-NBH8, S-NBH51, S-NBH52, S-NBH53, S-NBH55, S-NPH1, S-NPH2, S-NPH53, P-FK01S, P-FKH2S, P-SK5S, P-SK12S, P-LAK13S, P-LASF03S, P-LASFH11S, P-LASFH12S, without being restricted thereto.

The metallic glass can also be produced easily by molding. The metallic glass is exemplified in the Japanese Unexamined Patent Application Publication No. Hei 8-109419, Japanese Unexamined Patent Application Publication No. Hei 8-333660, Japanese Unexamined Patent Application Publication No. Hei 10-81944, Japanese Unexamined Patent Application Publication No. Hei 10-92619, Japanese Unexamined Patent Application Publication No. 2001-140047, Japanese Unexamined Patent Application Publication No. 2001-303218, and Tokuhyo 2003-534925, without being restricted thereto.

The optical surface of the master 10A can be the surface wherein the protruding section 14 is formed, or the surface wherein a plurality of protruding sections 14 are formed in an array, as shown in FIG. 2. The surface of the master 10A can be generated by cutting with a diamond.

If the optical surface of the master 1 OA is the surface wherein a single protruding section 14 is formed, such a material as nickel phosphorus, aluminum alloy or free cutting brass is used as the shape material, and the optical surface can be produced by turning operations using a diamond tool.

If the optical surface of the master 1 OA is the surface wherein a plurality of protruding sections 14 are formed in an array, the shape of the optical surface is provided with turning operations, using a ball end mill whose cutting blade is formed of a diamond. In this case, the cutting blade of the tool does not have a perfectly circular arc. An error occurs to the cutting shape depending on the position wherein the cutting blade is used. Thus, the cutting operation is preferably performed by adjusting the inclination of the cutting tool to ensure that the positions of the cutting blade to be used will be the same, independently of the portion of the optical surface to be cut.

The cutting machine is required to have three translational degrees of freedom and two rotary degrees of freedom to perform cutting operation. Thus, the machine is required to provide a total of five or more degree of freedoms. To form the optical surface of the master 10A, it is necessary to use the machine capable of providing a total of five or more degree of freedoms.

<Sub Master>

As shown in FIG. 2, the sub master 20 is made of a sub master molding part 22 and sub master substrate 26. The sub master molding part 22 has a plurality of recessed sections 24 formed in an array thereon. The surface of the recessed section 24 (molded surface) has a negative shape corresponding to the lens part 5 in the wafer lens 1. The recessed section 24 appears recessed in approximately semicircular shape in FIG. 2.

<Sub Master Molding Part>

The sub master molding part 22 is made of a resin 22A (second curable resin). A resin having excellent mold release characteristics, especially a transparent resin is preferably used as the resin 22A. The advantage is that mold releasing is possible without having to apply a mold releasing agent. Any one of the photocurable resin, thermosetting resin and thermoplastic resin can be used.

The photocurable resin is exemplified by a fluorine-based resin. The examples of thermosetting resin are fluorine-based resin and silicone-based resin. Of these resins, the preferred ones are those resins wherein mold release characteristics are excellent, namely, the surface energy is lower when cured. Thermosetting resin is exemplified by the olefin-based resin such as polycarbonate or cycloolefin polymer which is transparent and has comparatively good release characteristics. The release characteristics are enhanced in the order of fluorine-based resin, silicone-based resin and olefin-based resin. In this case, the sub master substrate 26 need not be used. Use of such a resin allows deflection to be made. This is a further advantage at the time of mold releasing.

The following describes fluorine-based resin, silicone-based resin and thermosetting resin.

(Fluorine-Based Resin)

Examples of fluorine-based resin include PTFE (polytetrafluoroethylene), PFA (tetrafluoroethylene.perfluoro alkyl vinylether copolymer), FEP (tetrafluoroethylene.hexafluoropropylene copolymer (4,6-fluoride), ETFE (tetrafluoroethylene.ethylene copolymer), PVDF (polyvinylidene fluoride (bifluoride)), FCTFE (polycchlorotrifluoroethylene (3-fluoride)), ECTFE (chlorotrifluoroethylene.ethylene copolymer), and PVF (polyvinyl fluoride).

The advantages of the fluorine-based resin are excellent release characteristics, heat resistance, chemical resistance and insulation as well as low abrasion. The disadvantages are lower transparency resulting from crystalline characteristics. Since the melting point is high, a high temperature (about 300° C.) is required at the time of molding.

The examples of the molding method include injection molding, extrusion molding, blow molding and transfer molding. FEP, PFA and PVDF are particularly preferred because of excellent light transmittance and the capability of ensuring injection molding and extrusion molding to be performed.

The grate that permits melt-molding is exemplified by Fluon PFA of Asahi Glass Co., Ltd., and Dyneon PFA and Dyneon THV of Sumitomo 3M. Especially, Dyneon THV series has a low melting point (about 120° C.), and permits molding to be performed at a relatively low temperature. Dyneon THV series is also characterized by high degree of transparency, and is therefore preferably used.

Further, as a thermo-hardening amorphous fluorine resin, CYTOP grade S manufactured by Asahi Glass Company is desirable, because it has a high transmittance and a good mold-release characteristic.

(Silicone-Based Resin)

A silicone type resin has one liquid component moisture hardening type, a two liquid component addition reaction type and a two liquid component condensation type.

The silicone type resin has advantages in mold-release characteristics, flexibility, heat resistance property, incombustibility, moisture permeability, low water absorption property, many transparent grades and the like, but has large linear expansion coefficient as drawback.

Especially the silicone resin for molding that contains PDMS (poly dimethyl siloxane) is preferably used because of satisfactory release characteristics. The highly transparent grade of RTV Elastomer is preferred. Preferred examples are TSE3450 (two-liquid mixture, additive type) of Momentive Performance Materials Inc., ELASTOSIL M 4647 (two-liquid type RTV silicone rubber) manufactured by WACKER ASAHIKASEI SILICONE CO., LTD., KE-1603 (two liquid mixture, additive type RTV rubber) manufactured by Shinetsu Silicone, SH-9555 (two liquid mixture, additive type RTV rubber), SYLGARD 184, SILPOT 184 and WL-5000 series (light sensitive silicone buffer material, patterning by UV is possible) manufactured by Dow Corning, Toray Co., Ltd, and the like may be employed.

For the two-liquid type RTV rubber, molding operation is performed by curing at a room temperature or at a heated temperature.

(Thermoplastic Resin)

The examples of thermoplastic resin include transparent resins such as alicyclic hydrocarbon-based resin, acryl resin, polycarbonate resin, polyester resin, polyether resin, polyamide resin and polyimide resin. Of these examples, the alicyclic hydrocarbon-based resin is particularly preferred. When the sub master 20 is composed of a thermoplastic resin, the conventionally used injection molding technique can be used directly, and the sub master 20 is produced with ease. If the thermoplastic resin is alicyclic hydrocarbon-based resin, the moisture absorbency is very low, and the service life of the sub master 20 is prolonged. Further, since the alicyclic hydrocarbon-based resin such as cycloolefin resin are characterized by excellent light resistance and light transmittance, there is no deterioration of the mold even when short-wavelength light such as UV light source is used to cure the actinic radiation curable resin. Thus, the mold can be used for a long period of time.

The alicyclic hydrocarbon-based resin is exemplified by the substance expressed by the following formula (1):

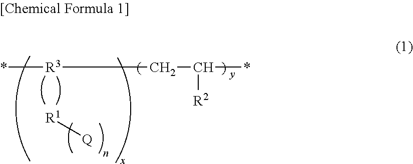

“x” and “y” in Formula 1 indicate copolymerization ratio, and are the real numbers meeting 0/100≦y/x/≦95//5. “n” is 0, 1 or 2 and indicates the number of replacements of the substituent Q. “R₁” indicates one or more types of the (2+n)-valent groups selected from among the hydrocarbon groups containing 2 through 20 carbon atoms. “R₂” is one or more types of the monovalent groups selected from among the structure groups of containing 1 through 10 carbon atoms, wherein “R₂” is a hydrogen atom or is made up of carbon and hydrogen. “R₃” indicates one or more types of the divalent groups selected from among the hydrocarbon groups containing 2 through 20 carbon atoms. “Q” indicates one or more types of groups having a valance of 1 selected from among the structure groups expressed by COOR₄ (wherein R₄ indicates one or more types of the monovalent groups selected from among the structure groups of containing 1 through 10 carbon atoms, wherein “R₄” is hydrogen or is made up of carbon and hydrogen).

In formula (1), R1 is preferably one or more types of the group having a valance of 2 selected from among the hydrocarbon groups containing 2 through 12 carbon atoms, more preferably a divalent group expressed by the following formula (2) (in formula (2), p is an integer from 0 through 2):

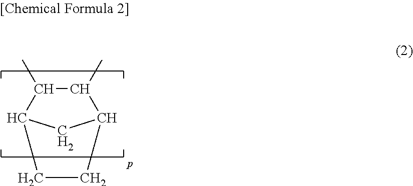

More preferably, R1 is a divalent group wherein p is 0 or 1 in formula (2). For the structure of R1, one type alone or a combination of two or more types can be used. The examples of R2 include a hydrogen atom, methyl group, ethyl group, n-propyl group, i-propyl group, n-butyl group, and 2-methyl propyl group. The preferred substance is a hydrogen atom and/or methyl group. The most preferred substance is the hydrogen atom. Examples of R3 as preferred examples of the structure unit including this group are the following formulae (a), (b) and (c) (wherein R1 in (a), (b) and (c) is the same as above), wherein n is 0:

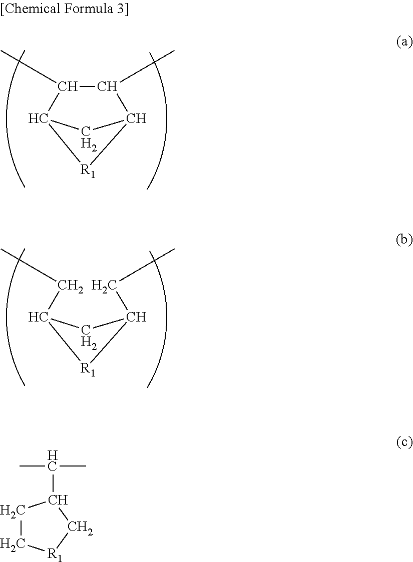

“n” is preferably 0.

In this embodiment, there is no restriction to the type of copolymer. Random copolymerization, block copolymerization, alternate copolymerization and commonly known type of copolymerization can be used. Of these, random copolymerization is preferred.

Further, the polymer used in the present embodiment can contain a repeated structural unit derived from other copolymerizable monomers, as required, if it does not damage the physical properties of the product obtained by the molding method in the present embodiment. There is no particular restriction to the copolymerization ratio. The copolymerization ratio is preferably 20 mole percent or less, more preferably 10 mole percent or less. If the percentage is greater, the optical properties may be lost and high-precision optical parts may not be obtained. There is no particular restriction to the type of copolymerization. Random copolymerization is preferred.

Another example of the thermoplastic alicyclic hydrocarbon-based polymer preferably applied to the sub master 20 is the polymer wherein the repeating unit having an alicyclic structure contains the repeating unit (a) having an alicyclic structure expressed by the following formula (4), and the repeating unit (b) having a chain structure expressed by the following formula (5) and/or (6) and/or (7) in such a way that the total content will be 90% by mass or more; and the content of the repeating unit (b) is 1% by mass or more through 10% by mass exclusive.

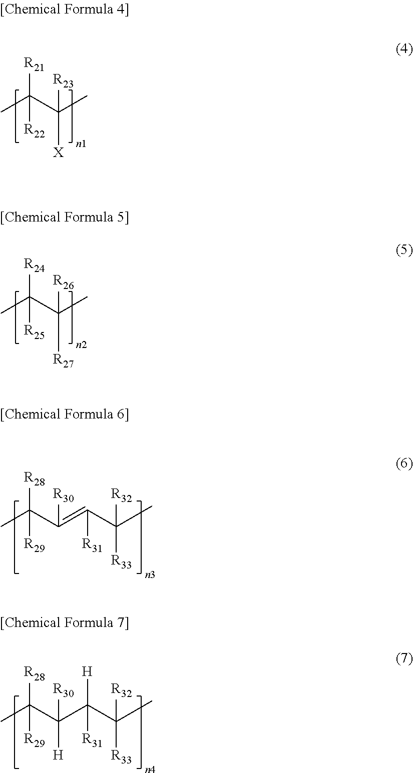

In the formulae (4), (5), (6) and (7), R21 through R33 are independently a hydrogen atom, a chain-shaped hydrocarbon group, a halogen atom, an alkoxy group, a hydoxy group, an ether group, an ester group, a cyano group, an amino group, an imido group, a silyl group, or a chain-shaped hydrocarbon group substituted with a polar group (a halogen atom, an alkoxy group, a hydoxy group, an ester group, a cyano group, an amide group, an imido group or a silyl group). Concretely, examples of a halogen atom include a fluorine atom, a chlorine atom, a bromine atom, and an iodine atom, and examples of a chain-shaped hydrocarbon group substituted with a polar group, include a halogenated alkyl group with 1 to 20 carbon atoms, preferably 1 to 10 carbon atoms, more preferably 1 to 6 carbon atoms. Examples of a chain-shaped hydrocarbon group include an alkyl group with 1 to 20 carbon atoms, preferably 1 to 10 carbon atoms, more preferably 1 to 6 carbon atoms, and an alkenyl group with 2 to 20 carbon atoms, preferably 2 to 10 carbon atoms, more preferably 2 to 6 carbon atoms.

X in the formula (4) indicates the alicyclic hydrocarbon group containing 4 through 20 carbon atoms, preferably 4 through 10 carbon atoms, more preferably 5 through 7 carbon atoms. If the number of carbon atoms constituting the alicyclic structure is kept within this range, birefringence can be reduced. Further, the alicyclic structure is not restricted to the monocyclic structure. For example, the multi-cyclic structure such as a norbornane ring can be used.

The alicyclic hydrocarbon group may contain a carbon-carbon unsaturated bond. The percentage of the content thereof is 10% or less of the overall carbon-carbon bond, preferably 5% or less of the overall carbon-carbon bond, more preferably 3% or less of the overall carbon-carbon bond. If the carbon-carbon unsaturated bond of the alicyclic hydrocarbon group is kept within this range, transparency and heat resistance will be improved.

Further, the carbons constituting the alicyclic hydrocarbon group may be made to bond with a hydrogen atom, a hydrocarbon group, a halogen atom, an alkoxy group, a hydroxy group, an ester group, a cyano group, an amide group, an imido group, a silyl group, or a chain-shaped hydrocarbon group substituted with a polar group (a halogen atom, an alkoxy group, a hydroxy group, an ester group, a cyano group, an amide group, an imido group, or a silyl group). Among them, a hydrogen atom or a chain-shaped hydrocarbon group with 1 to 6 carbon atoms is preferable in terms of heat resistance and low water absorption property.

Further, formula (6) contains a carbon-carbon unsaturated bond in the principal chain, and Formula (7) contains a carbon-carbon saturated bond in the principal chain. When there has been an intense demand for transparency and heat resistance, the percentage of content of the unsaturated bond is normally 10% or less of the carbon-carbon bond constituting the principal chain, preferably 5% or less, more preferably 3% or less.

In the present embodiment, the total content of the repeating unit (a) having an alicyclic structure expressed by the formula (4) in the alicyclic hydrocarbon, and the repeating unit (b) having an chain structure expressed by the formula (5) and/or (6) and/or (7) is normally 90% by mass or more, preferably 95% by mass or more, more preferably 97% by mass or more. If the total content is kept within this range, low birefringence, heat resistance and mechanical strength are kept in an advanced state of balance.

In one of the methods for producing the aforementioned alicyclic hydrocarbon copolymer, the principal chain and carbon-carbon unsaturated bond is hydrogenated by copolymerization with other monomers which is polymerizable with an aromatic vinyl compound.

The molecular weight of the copolymer before hydrogenation is 1,000 through 1,000,000, preferably 5,000 through 500,000, more preferably 10,000 through 300,000 in terms of mass average molecular weight (Mw) on the basis of polystyrene (or polyisoprene) as measured by the GPC. If the mass average molecular weight (Mw) of the copolymer is excessively small, the strength of the product of the alicyclic hydrocarbon copolymer obtained therefrom will be reduced. If the mass average molecular weight (Mw) is excessive, hydrogenation reactivity will be reduced.

Specific examples of the aromatic vinyl compound used in the aforementioned method are styrene, α-methylstyrene, α-ethylstyrene, α-propylstyrene, α-isopropylstyrene, α-t-butylstyrene, 2-methylstyrene, 3-methylstyrene, 4-methylstyrene, 2,4-diisopropylstyrene, 2,4-dimetylstyrene, 4-t-butylstyrene, 5-t-butyl-2-methylstyrene, monochlorostyrene, dichlorostyrene, monofluorostyrene, and 4-phenylstyrene. Styrene, 2-methylstyrene, 3-methylstyrene, and 4-methylstyrene are preferably used. These aromatic vinyl compounds can be used independently or in combination of two or more.

There is no particular restriction to other polymerizable monomers. The chain vinyl compound and chain conjugate diene compound are used. Use of the chain conjugate diene compound will provide excellent maneuverability in the production process and satisfactory strength of the alicyclic hydrocarbon copolymer having been obtained.

The specific examples of the chain compound are:

chain olefin monomer such as ethylene, propylene, 1-butene, 1-pentene and 4-methyl-1-pentene;

nitrile-based monomer such as 1-cyanoethylene (acrylonitrile), 1-cyano-1-methylethylene(methacrylonitrile) and 1-cyano-1-chloroethylene (a-chloroacrylonitrile);

ester-based monomer (metha)acrylate such as 1-(methoxycarbonyl)-1-methylethylene(methyl ester methacrylate), 1-(ethoxycarbonyl)-1-methylethylene (ethyl ester methacrylate), 1-(propoxycarbonyl)-1-methylethylene (propyl ester methacrylate), 1-(butoxycarbonyl)-1-methylethylene (butyl ester methacrylate), 1-methoxycarbonylethylene(methyl ester acrylate), 1-ethoxycarbonylethylene (ethyl ester acrylate), 1-propoxycarbonylethyl ethylene (propyl ester acrylate), and 1-butoxycarbonylethylene (butyl ester acrylate); and unsaturated fatty acid-based monomer such as 1-carboxyethylene (acrylate), 1-carboxy-1-methyl ethylene(methacrylate) and anhydrous maleic acid. Of these, chain-shaped olefin monomer is preferred. Ethylene, propylene and 1-butene are most preferably used.

The examples of chain-shaped conjugated diene are 1,3-butadiene, isoprene, 2,3-dimethyl-1,3-butadiene, 1,3-pentadiene and 1,3-hexadiene. Among these chain-shaped vinyl compounds and chain-shaped conjugated diene, the chain-shaped conjugated diene is desirable, and butadiene and isoprene are particularly desirable. These chain-shaped vinyl compounds and chain-shaped conjugated diene may be used solely respectively, or may be used in combination of two or more kinds.

There is no particular restriction to polymerization reaction. Radical polymerization, anion polymerization and cation polymerization can be used. The anion polymerization method is preferred when consideration is given to easy hydrogenation reaction in the polymerization maneuvering and post-process, and mechanical strength of the finally obtained hydrocarbon-based copolymer.

In the case of anion polymerization, methods of bulk polymerization, solution polymerization and slurry polymerization can be used within a temperature range of normally 0 through 200° C., preferably 20 through 100° C., more preferably 20 through 80° C. in the presence of initiator. When elimination of reaction heat is taken into account, solution polymerization is preferably used. In this case, the inert solvent capable of dissolving the polymer and hydrogenated substance thereof is used. The inert solvent used in the solution reaction is exemplified by:

fatty acid hydrocarbon such as n-butane, n-pentane, iso-pentane, n-hexane, n-heptane and iso-octane;

alicyclic hydrocarbon such as cyclopentane, cyclohexane, methylcyclopentane, methylcyclohexane, and decalin; and

aromatic hydrocarbon such as benzene and toluene.

The aforementioned anion polymerization initiator is exemplified by:

mono-organic lithium such as n-butyllithium, sec-butyllithium, t-butyllithium, hexyllithium and phenyllithium;

multifunctional organic lithium compound such as dilithiomethane, 1,4-diobutane, and 1,4-dilithio-2-ehylcyclohexane.

In the case of hydrogenation reaction such as carbon-carbon double bonding of the unsaturated ring including the aromatic ring and cycloalkene ring of the copolymer before hydrogenation, and unsaturated bonding of principal chain, there is no particular restriction to reaction method and reaction configuration. Hydrogenation reaction can be carried out according to the commonly known method. The preferred hydrogenation method should allow the percentage of hydrogenation to be increased, and should reduce the polymer chain cutting reaction that occurs simultaneously with hydrogenation reaction. One of the preferred methods uses the catalyst at least one metal selected from among organic solvent, nickel, cobalt, iron, titanium, rhodium, paradium, platinum, ruthenium, and rhenium. The hydrogenation reaction is normally carried out at 10 through 250° C. The temperature range from 50 through 200° C. is preferred, and the temperature range from 80 through 180° C. is more preferred because the percentage of hydrogenation can be increased, and the hydrogen pressure is normally 0.1 MPa through 30 MPa. The temperature range is preferably 1 MPa through 20 MPa, more preferably 2 MPa through 10 MPa from the viewpoint of maneuverability in addition to the aforementioned reasons.

The percentage of hydrogenation of the hydrogenated substance having been obtained in the aforementioned manner is normally 90% or more, preferably 95% or more, more preferably 97% or more, according to the measurement of ¹H-NMR in all of the carbon-carbon unsaturated bonding of the principal chain, carbon-carbon double bonding of the aromatic ring and carbon-carbon double bonding of the unsaturated ring. If the percentage of hydrogenation is lower, the birefringence and heat stability of the copolymer having been obtained will be reduced.

There is no particular restriction to the method of collecting the hydrogenated substance after completion of hydrogenation reaction. Normally, the residue of hydrogenated catalyst is removed by the filtering, centrifugal separation and other methods. After that, the solvent is directly removed by drying from the solution of the hydrogenated substance. Alternatively, the solution of hydrogenated substance is poured into the poor solvent for the hydrogenated substance so as to coagulate the hydrogenated substance.

<Sub Master Substrate>

The sub master substrate 26 is a backing material which increases the strength of the sub master 20 and allows repeated molding operation to be performed by attaching resin to the substrate, even if the sub master substrate 26 is insufficient when only the sub master molding part 22 of the sub master 20 is used.

Any material such as quartz, silicon wafer, metal, glass and resin can be used to form a sub master substrate 26 if it provides a high level of smoothness.

When consideration is given to the fact that ultraviolet rays can be applied either from the top and bottom of the sub master 20, from the viewpoint of transparency, a transparent mold, for example, quartz, glass or transparent resin is preferably used. Any of the thermoplastic resin, thermosetting resin and UV curable resin can be used as the transparent resin. Fine particles are contained in the resin, and this provides the effect of reducing the linear expansion coefficient. Use of such resin allows the glass to be deflected. This ensures easier separation from the mold. However, the resin has a greater linear expansion coefficient. If heat is generated during application of ultraviolet rays, deformation will occur, and high-precision transfer may be interrupted. This problem can be solved by using resin as the backing material. Glass can be used as the backing material in point of strength. However, for the aforementioned reasons, the difference in linear expansion is preferably small between the resin constituting the sub master molding part 22 and the resin constituting the backing material. The preferred difference in linear expansion is 3×10⁻⁵/K or less.

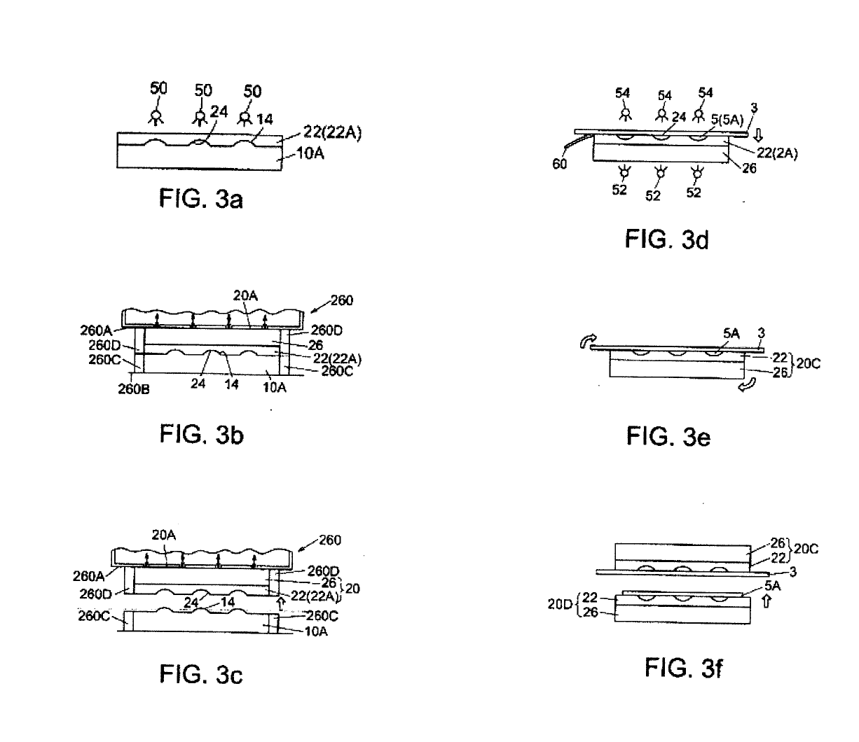

The following describes the method for producing the wafer lens 1 with reference to FIG. 3.

As shown in FIG. 3a, resin 22A is applied to the master 10A, and the protruding section 14 of the master 10A is transferred onto the resin 22A. The resin 22A is cured, and a plurality of recessed sections 24 is formed on the resin 22A. This arrangement allows a sub master molding part 22 to be formed.

The resin 22A can be the thermosetting resin, photocurable resin or volatile curable resin (e.g., HSQ (hydrogensilsesquioxane) which is cured by volatilization of solvent). When high-precision molding transferability is desired, molding is performed preferably by using the UV curable resin or volatile curable resin characterized by smaller impact of thermal expansion of the resin 22A since heat is not used for curing, without being restricted thereto. The resin 22A characterized by good separability from the master 10A after curing does not required much force at the time of separation. This resin is preferably used, without any inadvertent deformation on the shape of the optical surface to be molded.

When the resin 22A (material of the sub master molding part 22) and resin 5A (material of the lens parts 5) are curable resins, the shape of the optical surface (protruding section 14) of the master 10A is preferably designed in anticipation of possible curing shrinkages of the resin 22A and resin 5A.

When resin 22A is applied to the master 10A, the spray coat method or spin coat method is used. In this case, resin 22A can be applied under vacuum. Application of the resin 22A under vacuum allows the resin 22A to be cured, without air bubbles being mixed therein.

When the master 10A is provided with spray coating or spin coating, a mold releasing agent is preferably applied to the surface of the master 10A.

When a mold releasing agent is applied, the surface of the master 10A is modified. To put it more specifically, the OH group is activated on the surface of the master 10A. The surface can be modified by UV ozone washing, oxygen plasma ashing or any other method if the OH group can be activated on the surface of the master 10A.

The mold releasing agent is exemplified by a material with a hydrolyzable functional group bonded to the terminal thereof such as a silane coupling agent structure, namely, a material having the structure which will be bonded by dehydration and condensation with the OH group on the surface of metal, or hydrogen bonding. For the mold releasing agent the one terminal of which has a silane coupling structure and the other terminal of which has a releasing agent having release characteristics, as the amount of the OH group formed on the surface of the master is greater, there will be an increasing number of points wherein covalent bonding occurs on the surface of the master 10A. This ensures more rigid bonding. As a result, the mold releasing effect is not reduced despite repeated molding operations. Thus, the durability is improved. Further, this arrangement eliminates the need of using the primer (underground layer, SiO₂ coating, etc.). This arrangement eliminates the need of using the primer (underground layer, SiO₂ coating, etc.). Durability can be improved with the thin film maintained.

The preferred examples of the “material with a hydrolyzable functional group bonded to the terminal thereof” are the materials made of an alkoxysilane group, halogenated silane group, quaternary ammonium salt or phosphoric acid ester group, as the functional group. The group which forms a strong bondage with the mold, such as triazinethiol, may be bonded to the terminal group. To put it more specifically, this material contains the alkoxy silane (8) or halogenated silane group (9) shown by the following general formula.

—Si(OR1)nR2(3−n) (8)

—SiXmR3(3−m) (9)

wherein R1 and R2 indicate an alkyl groups (e.g., a methyl group, an ethyl group, a propyl group and a butyl group), and n and m indicate 1, 2 or 3 respectively. R3 is an alkyl group (e.g., methyl group, ethyl group, propyl group and butyl group) or alkoxy group (e.g., methoxy group, ethoxy group, and butoxy group). X denotes the halogen atom (e.g., Cl, Br, I).

When two or more of R1, R2, R3 and X are bonded to Si, they may be different within the range of the groups or atoms indicated above, for example, just as two Rm's are alkyl group and alkoxy group.

The alkoxy silane group —SiOR1 and halogenated silane group —SiX is converted into —SiOH by reaction with water, and —SiOH is then bonded with the OH group present on the surface of the mold material such as a metal through dehydration and condensation or hydrogen bonding.

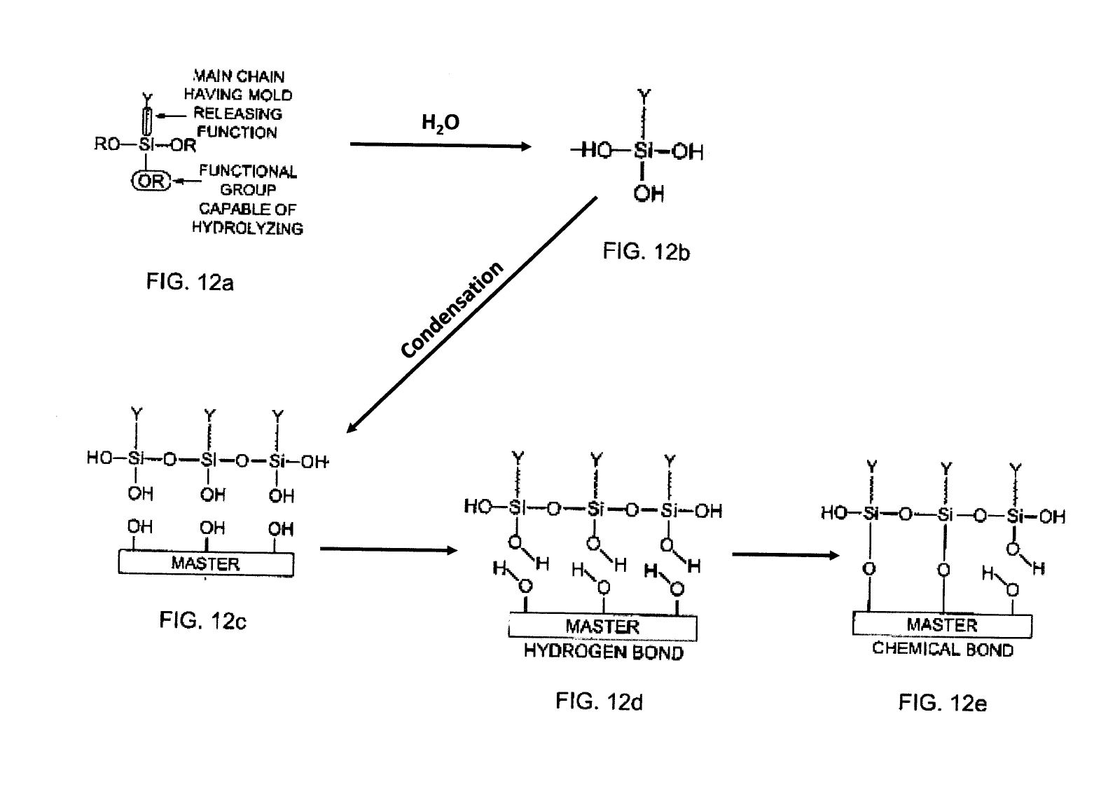

FIG. 12 is a diagram showing the reaction between the mold releasing agent using an alkoxy silane group and the OH group on the surface of the master 10A as an example of the hydrolyzable functional group at the terminal.

In FIG. 12a, —OR indicates methoxy (—OCH₃ and ethoxy (—OC₂H₅). Methanol (CH₃OH) and ethanol (C₂H₅OH) are generated by hydrolysis to produce silanol (—SiOH) of FIG. 12b. After that, a condensate of silanol is provided, as shown in FIG. 12c, by partial dehydration and condensation. Adsorption occurs by bonding between the OH group on the surface of the master 10 (inorganic material) and hydrogen, as shown in FIG. 12d. In the final step, dehydration occurs, as shown in FIGS. 12e, and —O— chemical bonding (covalent bonding) takes place. FIG. 12 shows the example of the alkoxy silane group. Basically the same reaction occurs in the case of a halogenated silane group.

To be more specific, one terminal of the mold releasing agent used in the present invention is chemically bonded with the surface of the master 10A, and the functional group is oriented at the other terminal so that the master 10A is covered. This produces a thin, durable and uniform mold releasing agent.

The preferred structure on the side provided with a mold releasing function is that the surface energy should be low. An example is found in the fluorine-substituted hydrocarbon group or hydrocarbon group.

<Fluorine-Based Mold Releasing Agent>

The fluorine-substituted hydrocarbon group preferably used has a perfluoro group (wherein a and b indicate an integer) such as CF3(CF2)a- group and CF3.CF3.CF(CF2)b- group on one terminal of the molecular structure. The preferred length of the perfluoro group is equivalent to two or more carbon atoms. The number of the CF2 groups following the CF3 of the CF3(CF2)a- is preferably 5 or more.

The perfluoro group need not have a straight chain structure. It can have a branched chain structure. To cope with the environmental problems in recent years, such a structure as CF3(CF2)c-(CH2)d-(CF2)e- is also acceptable. In this case, c is 3 or less, d is an integer (preferably 1) and e is 4 or less.

The aforementioned fluorine mold releasing agent is normally solid. To apply this agent on the surface of the master 10A, it is necessary to produce a solution by dissolving in an organic solvent. Although there will be a difference depending on the molecular structure of the mold releasing agent, the preferably used solvent is the solvent of hydrocarbon fluoride or the solvent of hydrocarbon fluoride provided with a small amount of organic solvent, in many cases. There is no particular restriction to the concentration of the solvent. Since the required mold releasing film is particularly thin, a low concentration of 1 through 3% by mass is sufficient.

To apply this solution on the surface of the master 10A, it is possible to use a commonly practiced method such as dip coating, spray coating, brush coating or spin coating. After coating, the solvent is evaporated by natural drying to get a dry coated film. The coated film thickness in this case is preferably 20 μm or less.

To put it more specifically, the examples include Optool DSX, Durasurf HD-1100 and HD-2100 of Daikin Industries Ltd., Nobeck EGC1720 of Sumitomo 3M Limited, vapor deposition of triazinethiol of Takeuchi Shinkuhimaku Co., Ltd., amorphous fluorine SAITOP Grade M of AGC, and stain proof coat OPC-800 of N.I.Material.

(Hydrocarbon-Based Mold Releasing Agent)

The hydrocarbon can have a structure of straight chain as in CnH2n+1. The structure can also be a branched chain structure. The silicone-based mold releasing agent is preferably used.

In the conventional method, there has been a great number of commonly known compositions used to form the cured coated film that exhibits water repellency wherein organopolysiloxane resin is the major component. For example, the Japanese Unexamined Patent Application Publication No. Sho 55-48245 proposes a composition for forming a water-repellent coated film which is made of a methylpolysiloxane resin containing a hydroxyl group, α,ω-dihydroxy diorgano polysiloxane and organosilane and is characterized by excellent release characteristics and stain-proof property after having been cured. Further, the Japanese Unexamined Patent Application Publication No. Sho 59-140280 proposes a composition whose major agent is the partially cohydrolyzed condensate of the organosilane mainly composed of organosilane containing a perfluoro alkyl group and organosilane containing amino group, and this component is cured to produce a coated film characterized by excellent water and oil repellency.

Specific examples are Mold Spat of AGC Seimi Chemical, Orgatics SIC-330, 434 Matsumoto Fine Chemical, and SR-2410 Toray Dow Chemical. SAMLAY of Nippon Soda can be mentioned as a self-organizing monomolecular film.

As shown in FIG. 3a, when the resin 22A is a photocurable resin, a light source 50 arranged above the master 10A is turned on for irradiation.

The examples of the light source 50 include a high pressure mercury lamp, metal halide lamp, xenon lamp, halogen lamp, fluorescent lamp, black light, G-lamp and F-lamp. Either a linear light source can or punctiform light source can be used. The high pressure mercury lamp has a narrow spectrum of 365 nm and 436 nm. The metal halide lamp is a type of the mercury lamp, and the output in the ultraviolet region is several times higher than that of the high pressure mercury lamp. The xenon lamp has the spectrum closest to that of the solar light. The halogen lamp contains many rays of long wavelength, and almost all the light emitted is near-infrared light. The fluorescent lamp has an irradiation intensity which is uniform for three primary colors. The black light has a peak top of 351 nm, and emits a near-ultraviolet ray having a wavelength of 300 nm through 400 nm.

When irradiation is provided from the light source 50, a plurality of linear or punctiform light sources 50 can be arranged in a grid-like pattern so that light will be applied to all the surfaces of the resins 22A in one operation. Alternatively, the linear or punctiform light sources 50 can be applied parallel to the surface of the resin 22A so that light will sequentially reach the resin 22A. In this case, distributions of the brightness and illuminance (intensity) are preferably measured at the time of irradiation, and the number of irradiations, dose and time duration of irradiation are controlled based on the result of this measurement.

After the resin 22A has been photocured (after production of the sub master 20), the sub master 20 can be post-cured (heated). Post-curing allows the resin 22A of the sub master 20 to be completely cured, so that the service life of the sub master 20 will be prolonged.

When the resin 22A is a thermosetting resin, the resin 22A is heated while the heating temperature and time are controlled within the optimum range. The resin 22A can also be molded by the processes of injection molding, press molding, irradiation and cooling.

As shown in FIG. 3b, the sub master substrate 26 is mounted on the rear (opposite the recessed sections 24) of the sub master molding part 22 (resin 22A), and the sub master molding part 22 is backed.

The sub master substrate 26 can be made of quartz or glass plate. What is important is sufficient bending strength and UV transmittance. To enhance adhesion between the sub master molding part 22 and sub master substrate 26, a silane coupling agent may be applied to the sub master substrate 26, or similar measures can be taken.

As described above, the protruding section 14 of the master 10A is transferred onto the resin 22A. An adhesive is used to mount the sub master substrate 26 in position (backing provided at a room temperature) after the resin 22A has been cured (after the sub master molding part 22 has been formed).

Conversely, it is also possible to adopt such a structure that the protruding section 14 of the master 10A is transferred into the resin 22A, and the sub master substrate 26 is mounted in position (backed at a room temperature) before the resin 22A is cured. In this case, the sub master substrate 26 is bonded by the adhesion of the resin 22A, without using the adhesive. Alternatively, a coupling agent is applied to the sub master substrate 26 to reinforce the adhesion, and the sub master substrate 26 is bonded to the resin 22A.

When the sub master molding part 22 (resin 22A) is backed by the sub master substrate 26, it is preferred that the sub master substrate 26 should be sucked onto the suction surface 260A of the vacuum chuck apparatus 260, and should be kept in that position, using a conventionally known vacuum chuck apparatus 260, so that the suction surface 260A is parallel with the molding surface of the protruding section 14 in the master 10A. Under this condition, the sub master molding part 22 is preferably backed by the sub master substrate 26. This procedure allows the rear surface 20A (surface on the side of the sub master substrate 26) of the sub master 20 to be kept parallel to the molding surface of the protruding section 14 in the master 10A. Then, as will be described later, when molding the lens parts 5 by the sub master 20, the reference surface of the sub master 20, namely, the rear surface 20A can be kept parallel to the molding surface of the recessed sections 24. This improves the geometric precision of the lens part 5, by preventing the lens part 5 from being decentered or variances in thickness from occurring. Further, since the sub master 20 can be sucked and held in position by the vacuum chuck apparatus 260, the sub master 20 can be mounted or dismounted only by the vacuum exhaust gas on/off operation. This ensures easy layout of the sub master 20.

In this case, “the rear surface 20A is parallel to the molding surface of the recessed sections 24” signifies that the rear surface 20A is perpendicular to the center axis on the molding surface of the recessed sections 24.

The sub master 20 is preferably cured while being backed by the sub master substrate 26. The sub master 20 can also be cured and formed before being backed. In one of the methods of curing by backing with the sub master substrate 26, for example, the thermosetting resin as the resin 22A is used, and the space between the master 10A and sub master substrate 26 is filled with resin 22A. These materials are then put into a baking furnace. In another method, an UV curable resin is used as the resin 22A and a UV-transparent substrate is utilized as the sub master substrate 26. The space between the master 10A and sub master substrate 26 is applied with resin 22A. Under this condition, ultraviolet rays are applied to the resin 22A from the side of the sub master substrate 26.

The suction surface 260A of the vacuum chuck apparatus 260 is preferably made of a ceramic material. In this case, the hardness of the suction surface 260A is increased and the suction surface 260A is not easily scratched by mounting or dismounting of the sub master 20 (sub master substrate 26). This ensures a high surface precision of the suction surface 260A to be maintained. Further, silicon nitride or sialon is used as such a ceramic material. In this case, the linear expansion coefficient is as small as 1.3 ppm. This ensures that the parallelism of the suction surface 260A with respect to humidity change is maintained at a high level.

The present embodiment employs the following method to keep the vacuum chuck apparatus 260 parallel to the molding surface of the master 10A.

In the first place, the front and rear surfaces of the master 10A are kept parallel to a high level. This will maintain the molding surface and rear surface of the protruding section 14 to be parallel to each other in the master 10A.

Reference members 260C and 260D are protruded from the supporting surface 260B for supporting the master 10A from the side of the rear surface (opposite the protruding section 14), and the suction surface 260A, respectively. In this case, reference members 260C and 260D should be so configured as to ensure that the master 10A and sub master 20 can be brought in contact with each other without any play, if the master 10A and sub master 20 have come in contact with each other when the supporting surface 260B and suction surface 260A are kept parallel to each other.

This arrangement ensures that the supporting surface 260B of the master 10A, hence the molding surface of the protruding section 14 in the master 10A, is maintained parallel to the suction surface 260A by mutual contact between the reference members 260C and 260D.

In the aforementioned methods, the reference member can be provided on at least one of the supporting surface 260B and suction surface 260A. For example, when a reference member is provided only on the supporting surface 260B, the reference member should be so configured that the master 10A and sub master 20 can be brought in contact with each other without any play occurring to the suction surface 260A, if the master 10A and sub master 20 have come in contact when the supporting surface 260B and suction surface 260A are parallel to each other. Similarly, when a reference member is provided only on the suction surface 260A, the reference member should be so configured that the master 10A and sub master 20 can be brought in contact with each other without any play occurring to the supporting surface 260B, if the master 10A and sub master 20 have come in contact when the supporting surface 260B and suction surface 260A are parallel to each other.

As shown in FIG. 3c, the sub master molding part 22 and sub master substrate 26 are separated from the master 10A, and the sub master 20 is formed.

When resin such as PDMS (polydimethyl siloxane) is employed as the resin 22A, satisfactory release characteristics with respect to the master 10 can be obtained. Release from the master 10 does not require much force and the molding optical surface is not distorted.

As shown in FIG. 3d, curing is carried out by filling the pace between the sub master 20 and glass substrate 3 with resin 5A. To put it in more detail, the resin 5A is put into the recessed sections 24 of the sub master 20, and the glass substrate 3 is pressed from the top thereof until the resin 5A is cured.

When the recessed sections 24 of the sub master 20 are filled with the resin 5A, the spray coating or spin coating method is used to apply resin 5A to the sub master 20. In this case, the resin 5A can be applied under vacuum. If the resin 5A is applied under vacuum, the resin 5A can be cured without being mixed with air bubbles.

Instead of filling the recessed sections 24 of the sub master 20 with the resin 5A, resin 5A can be applied on the glass substrate 3 and the glass substrate 3 coated with the resin 5A can be pressed against the sub master 20.

When the glass substrate 3 is pressed, the glass substrate 3 is preferably provided with the structure that allows shaft adjustment with the sub master 20. If the glass substrate 3 is circular, it is preferably provided with D-cutting, I-cutting, marking or notching. The glass substrate 3 can be made polygonal. This will facilitate shaft adjustment with the sub master 20.

To cure the resin 5A, irradiation can be provided from the side of the sub master 20 for turning on the light source 52 arranged below the sub master 20. Alternatively, irradiation can also be provided from the side of the glass substrate 3 by turning on the light source 54 above the glass substrate 3. Further, irradiation can also be provided from both sides of the sub master 20 and glass substrate 3 by turning on the light sources 52 and 54 simultaneously.

Similarly to the case of the light source 50, a high pressure mercury lamp, metal halide lamp, xenon lamp, halogen lamp, fluorescent lamp, black light, G-lamp and F-lamp can be used as the light sources 52 and 54. Either a linear light source can or punctiform light source can be used.

When irradiation is carried out from the light sources 52 and 54, a plurality of linear punctiform light sources 52 and 54 can be arranged in a grid pattern so that light will be applied to the resin 5A in one operation. Alternatively, the linear or punctiform light sources 52 and 54 can be applied parallel to the sub master 20 and glass substrate 3 so that light will sequentially reach the resin 5A. In this case, distributions of the brightness and illuminance (intensity) are preferably measured at the time of irradiation, and the number of irradiations, dose and time duration of irradiation are controlled based on the result of this measurement.

When the resin 5A has been cured, the lens part 5 is formed. After that, the lens part 5 and glass substrate 3 is separated from the sub master 20, and the wafer lens 1 is produced (the wafer lens 1 is formed only on the surface of the glass substrate 3).

When the wafer lens 1 is to be separated from the sub master 20, the stretching allowance 60 can be provided in advance between the wafer lens 1 and sub master 20 (FIG. 3d) so that the wafer lens 1 is separated from the sub master 20 by pulling the stretching allowance 60.

It is also possible to adopt such a structure that, when the sub master substrate 26 of the sub master 20 is made of an elastic material (resin), the wafer lens 1 is separated from the sub master 20 by slightly bending the sub master substrate 26. It is also possible to adopt such a structure that, when the glass substrate 3 is an elastic material (resin) instead of glass, the wafer lens 1 is separated from the sub master 20 by slightly bending the glass substrate 3.

Further, if the wafer lens 1 is separately slightly from the sub master 20 and so that a space is formed between these members, air or pure water can be pressure-fed into the space so that the wafer lens 1 is removed from the sub master 20.

In the above description, reference has been made to the method of providing the lens part 5 on one side of the glass substrate 3. When the lens parts 5 are provided on both sides, a step is taken to prepare a master (not illustrated) containing a plurality of the positive molding surfaces corresponding to the optical surface shape of the lens part 5 on one side of the glass substrate 3, and a master containing a plurality of the positive molding surfaces corresponding to the optical surface shape of the lens part 5 on the other side of the glass substrate 3. Sub masters 20C and 20D (FIGS. 3e and 3f) are formed using these masters. This allows the sub master 20C to have the negative molding surfaces corresponding to the optical surface shape of the lens part 5 on one side of the glass substrate 3, and permits the sub master 20D to have the negative molding surfaces corresponding to the optical surface shape of the lens part 5 on the other side of the glass substrate 3. After the space between the each of the sub masters 20C and 20D and the glass substrate 3 has been filled with the resin 5A, the resin 5A is cured, and the lens parts 5 are formed on both sides of the glass substrate 3. This procedure allows the resin 5A to be cured and shrunken on both sides simultaneously so that lens parts 5 are formed on both sides, without the resin 5A being cured and shrunken only on one side of the glass substrate 3. This arrangement prevents the glass substrate 3 from being deflected, differently from the cases wherein lens parts 5 are sequentially formed one by one on each side. Thus, the geographic precision of the lens part 5 is enhanced.

It is also possible to arrange such a configuration that, when the lens parts 5 are formed on both sides of the glass substrate 3, light is applied to both sides to cure the resin 5A. After that, heating is carried out (in a post-cure process). If the post-cure process is provided, the lens part 5 is cured and shrunken after having been taken out of the sub master. This prevents precision from being deteriorated, and enhances the transfer precision. Further, when the sub masters 20C and 20D are provided on both sides of the glass substrate 3, it is also possible to arrange such a configuration that heating is once carried out. After having been removed from the sub master, heating is carried out again in an independent process. This configuration allows curing and shrinkage to be controlled to some extent in the first heating process. The hardness of the lens can be upgraded by re-heating. Not only that, the time of using the sub master can be reduced. Hence, production efficiency is improved. Further, when the sub masters 20C and 20D are provided on both sides of the glass substrate 3, heating can be preferably performed several times at different temperatures. Heating is carried out at a lower temperature in the first heating process, whereby curing is promoted. Thus, curing and shrinkage subsequent to removal can be reduced. In the second heating process, heating is performed at a temperature higher than that in the first heating process. This ensures effective separation from the sub master.

Two methods are available to fill the space between the sub masters 20C and 20D with the resin 5A.

In one of these methods, as shown in FIGS. 3e and 3f, the resin 5A is dropped or discharged onto the top surface of the sub master 20C. After that, the sub master 20C and the glass substrate 3 arranged there above are brought into contact with each other and the space between the glass substrate 3 and sub master 20C is filled with resin 5A. Then, the glass substrate 3 and sub master 20C are brought in contact with each other, and are reversed as one integral body in the vertical direction. The resin 5A is dropped or discharged the top surface of the sub master 20D. After that, the sub master 20D and glass substrate 3 arranged thereabove are brought in contact with each other. The space between the glass substrate 3 and sub master 20D is filled with resin 5A.

In the other method, resin 5A is dropped or discharged the top surface of the glass substrate 3. Then the glass substrate 3 and the sub master 20C arranged thereabove are brought in contact with each other and the space between the glass substrate 3 and sub master 20C is filled with resin 5A. The resin 5A is dropped or discharged the top surface of the sub master 20D. Then the sub master 20D and glass substrate 3 arranged thereabove are brought in contact with each other, and the space between the glass substrate 3 and sub master 20D is filled with resin 5A.

When the glass substrate 3 and sub masters 20C and 20D are to be brought in contact with each other, means should preferably be taken to ensure that air bubbles will not remain. Further, the thermosetting resin, UV curable resin or volatile resin (such as HSQ) can be used as the resin 5A used in this case. When the UV curable resin is used, at least one of the sub masters 20C and 20D should be transparent to ultraviolet rays. This arrangement allows ultraviolet rays to be applied to resin 5A on both sides of the glass substrate 3 from one of the sub masters in one operation.

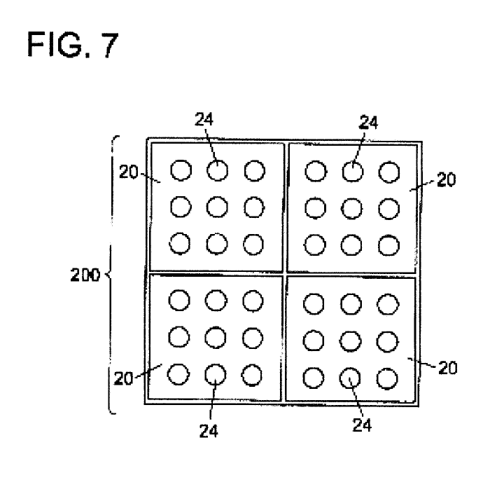

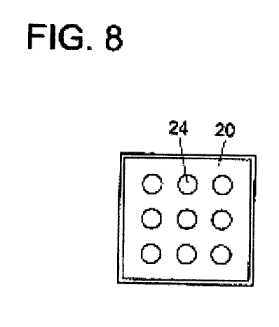

When the lens part 5 is formed on both the front and rear sides of the glass substrate 3, a step is taken to prepare a large-diameter sub master 200 as an integral unit obtained by enlarging the sub master 20 two times in each of the vertical and horizontal directions (magnification is changeable), and a regular sub master 20 of FIG. 8, as shown in FIG. 7. It is also possible to arrange such a configuration that, when the lens part 5 is formed on the front side of the glass substrate 3, the sub master 200 is used; and when the lens part 5 is formed on the rear surface opposite thereto, the sub master 20 is used several times.

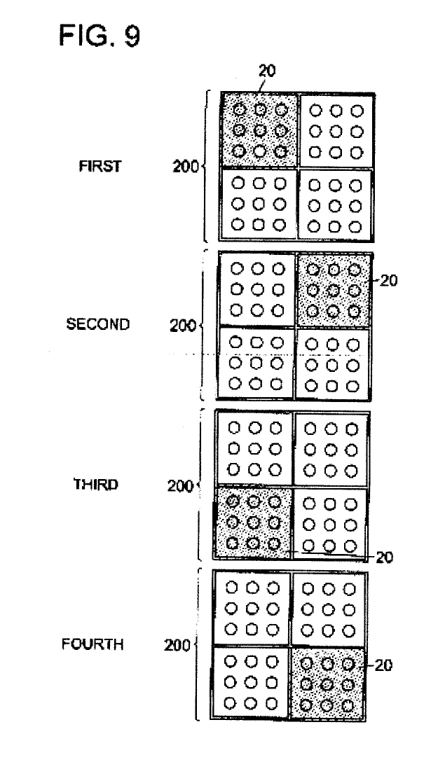

To put it more specifically, for the surface of the glass substrate 3, the large-diameter sub master 200 is used to form the lens part 5 in one operation. For the rear surface of the glass substrate 3 thereafter, as shown in FIG. 9, the sub master 20 is shifted by a quarter segment of the large-diameter sub master 200 at a time. Thus, the lens part 5 is formed using the sub master 20 four times. This structure facilitates shaft adjustment of the sub master 20 with the glass substrate 3 having the lens part 5 formed by using the large-diameter sub master 200. This arrangement ensures that the lens part 5 formed by using the large-diameter sub master 200 and the lens part 5 formed by using the sub master 20 will not be displaced on the front and rear sides of the glass substrate 3.

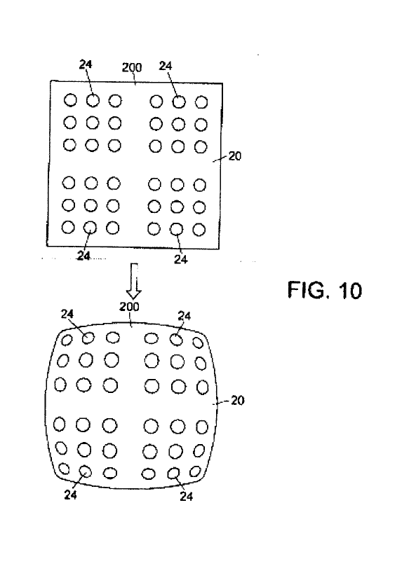

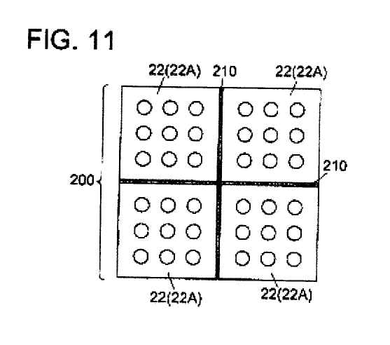

However, when the large-diameter sub master 200 is used, a slight curvature may occur to the sub master molding part 22, as shown in the upper level to the lower level of FIG. 10. Thus, the original function of the mold may not be demonstrated in some cases. To solve this problem, as shown in FIG. 11, the central portion is preferably provided with the region (stress relaxing section 210) wherein resin 22A is absent in the shape of a cross in such a way that the large-diameter sub master 200 is split. This structure suppresses the curvature of the sub master molding part 22 of the large-diameter sub master 200 (wherein the stress with respect to the glass substrate 3 is suppressed). The stress relaxing section 210 can be the region wherein the resin 22A is absent, as in the present embodiment, or can be provided with a thin layer of resin. Further, stress relaxing sections 210 can be provided at space intervals equivalent to a prescribed number of lens molding sections. Alternatively, stress relaxing sections 210 can be provided so as to surround each of the lens molding sections. If the aforementioned stress relaxing sections are provided, the curvature of the sub master 20 can be suppressed. Not only that, displacement in the direction of surface due to shrinkage, and deterioration in molding precision are also suppressed.

When the stress relaxing section 210 is provided and the resin 22A, for example, is a photocurable resin, the glass substrate 3 or sub master substrate 26 should be masked to form a region unexposed to light. Alternatively, the light sources 52 and 54 should be masked to form a region unexposed to light.

The wafer lens 1 can be produced directly from the master 10B by using the master 10B instead of the master 1 OA, without producing the sub master 20.

In this case, the recessed section 16 of the master 10B is filled with the resin 5A. The glass substrate 3 is pressed from the top thereof until the resin 5A is cured. After that, the glass substrate 3 and lens part 5 are removed from the master 10B.

What is important is the step of mold releasing wherein the resin 5A is released from the master 10B. Two methods are available to release the mold.

In one of these methods, a mold releasing agent is added to the resin 5A. In this case, the adhesion of the anti-reflection coating agent in the post process may be deteriorated or the force of bonding with the glass substrate 3 may be reduced. To prevent this, a coupling agent is preferably applied to the glass substrate 3 to reinforce the adhesive capability.

In the second method, the surface of the master 10B is coated with a mold releasing agent. The mold releasing agent that forms a triazinedithiol, fluorine- or silicon-based monomolecular layer can be used as the mold releasing agent. Use of the mold releasing agent allows coating to be performed up to a thickness of about 10 nm, which does not affect the optical surface shape. To increase the degree of adhesion and to ensure that the mold releasing agent will not be separated at the time of molding, the degree of adhesion is preferably enhanced by coating the master 10B with a coupling agent may be applied to the master 10B or SiO₂ for crosslinking between the mold releasing agent and master 10B.

### Embodiment 2

The second embodiment is different from the first embodiment in the following points. They are approximately the same, otherwise.

In the production of the wafer lens 1, the master 10, sub-sub master 30, sub master 40 shown in FIG. 4 is used as a mold. In the first embodiment, the sub master 20 is used to produce the wafer lens 1 from the master 10 (10A). By contrast, in the second embodiment, two molds—a sub master 30 and a sub-sub master 40—is used mainly to produce the wafer lens 1 from the master 10 (10B). This is the difference between the two embodiments. In particular, the process of producing the sub master 30 from the master 10B and the process of producing the wafer lens 1 from the sub-sub master 40 in the second embodiment is approximately the same as those in the first embodiment. The production of the sub-sub master 40 from the sub master 30 is the difference.

As shown in FIG. 4, the master 10B is the mold composed of a plurality of recessed sections 16 formed in an array on the base part 12 as a rectangular parallelepiped. The recessed section 16 is formed in a negative shape corresponding to the lens part 5 of the wafer lens 1. In FIG. 4, the shape is approximately hemispherical.

The master 10B can be made of such a material as nickel phosphorus, aluminum alloy or free cutting brass, and the optical surface thereof can be produced by cutting operations using a diamond tool. Alternatively, the master 10B can be produced by grinding such a material as cemented carbide. A plurality of recessed sections 16 can be mounted in an array preferably on the optical surface created by the master 10B, as shown in FIG. 4. Alternatively, a single recessed section 16 can be arranged on the optical surface created by the master 10B, as shown in FIG. 4.

As shown in FIG. 4, the sub master 30 is composed of a sub master molding part 32 and sub master substrate 36. A plurality of protruding sections 34 are formed in an array on the sub master molding part 32. The protruding section 34 is formed in a positive shape corresponding to the lens part 5 of the wafer lens 1. In FIG. 4, the protruding section 34 is protruded in an approximately hemispherical shape. The sub master molding part 32 is formed of a resin 32A.

The resin 32A can basically use the same material as that of the resin 22A of the sub master 20 in the first embodiment. It is particularly preferred to use the resin characterized by excellent release properties and heat resistance, and small liner expansion coefficient (i.e., resin of smaller surface energy). To put it more specifically, any of the aforementioned photocurable resin, thermosetting resin and thermoplastic resin can be used. It can be either transparent or non-transparent. However, for example, if a thermosetting resin is used, the aforementioned fluorine-based resin must be used. If a silicone-based resin is used, deformation will occur at the time of thermal transfer onto the sub master 40 because the linear expansion coefficient is high. Correct transfer of fine structures cannot be achieved.

The sub master substrate 36 can use the same material as that of the sub master substrate 26.

As shown in FIG. 4, the sub-sub master 40 is made of a sub-sub master molding part 42 and sub master substrate 46. A plurality of recessed sections 44 are formed in an array on the sub master molding part 42. The recessed sections 44 are the portions corresponding to the lens parts 5 of the wafer lens 1, and are recessed in an approximately hemispherical shape. This sub-sub master molding part 42 is formed of resin 42A.

The resin 42A can also use the same material as that of the resin 22A of the sub master 20 in the first embodiment. Use of the silicone resin or olefin resin is preferred because it can be deflected and is characterized by easy mold releasing properties.

The sub-sub master substrate 46 can also use the same material as that of the sub master substrate 26.

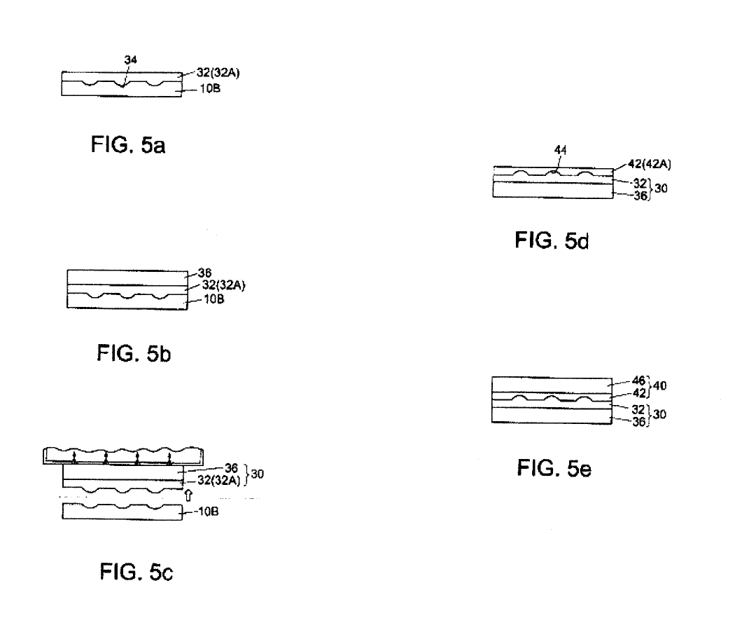

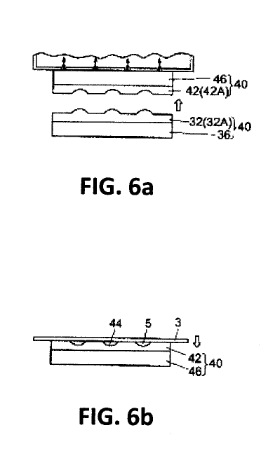

The following briefly describes the method for producing the wafer lens 1 with reference to FIGS. 5 and 6.

As shown in FIG. 5a, the resin 32A is applied on the master 10B and is cured. The recessed section 16 of the master 10B is transferred onto the resin 32A so that a plurality of protruding sections 34 are formed on the resin 32A. This procedure allows a sub master molding part 32 to be formed.

As shown in FIG. 5b, the sub master substrate 36 is bonded to the sub master molding part 32.

After that, as shown in FIG. 5c, the sub master molding part 32 and sub master substrate 36 are released from the master 10B, whereby the sub master 30 is produced.

After that, as shown in FIG. 5d, the resin 42A is applied on the sub master 30 and the resin 42A is cured. Then the protruding sections 34 of the sub master 30 are transferred onto the resin 42A so that a plurality of recessed sections 44 are formed on the resin 42A. This procedure allows a sub-sub master molding part 42 to be formed.

After that, as shown in FIG. 5e, the sub master substrate 46 is mounted on the sub-sub master molding part 42.

As shown in FIG. 6a, the sub-sub master molding part 42 and sub-sub master substrate 46 are released from the sub master 30, whereby the sub-sub master 40 is formed.

As shown in FIG. 6b, the recessed sections 44 of the sub-sub master 40 is filled with resin 5A and the glass substrate 3 is pressed from the above until the resin 5A is cured. As a result, the lens part 5 is formed from the resin 5A. After that, the lens part 5 and glass substrate 3 are released from the sub-sub master 40, whereby the wafer lens 1 is formed (wherein, in the wafer lens 1, the lens part 5 is formed only on the surface of the glass substrate 3).

The lens part 5 is formed also on the rear surface of the glass substrate 3. When lens parts 5 are to be formed on both the front and rear surfaces of the molding surface, a step is taken to prepare a master (not illustrated) having a plurality of negative molding surfaces corresponding to the optical surface shape of the lens part 5 on one surface of the glass substrate 3, and a master (not illustrated) having a plurality of negative molding surfaces corresponding to the optical surface shape of the lens part 5 on the other surface. Each of these masters is used to form a sub master having a positive molding surface. Each of these masters is also used to form a sub master. The space between each of the sub masters and glass substrate 3 is filled with resin 5A. After that, the resin 5A is cured, and lens parts 5 are formed on both surfaces of the glass substrate 3.

What is claimed is:

1. A method for producing a wafer lens in which a first optical member made of a photocurable first hardening resin is provided on one side of a glass substrate and a second optical member made of a photocurable second hardening resin is provided on the other side of the glass substrate, is characterized by comprising:
molding a first sub master molding part having a plurality of molding surfaces with a negative configuration corresponding to an optical surface configuration of the first optical member by using a transparent third hardening resin, from a first master mold having a plurality of molding surfaces with a positive configuration corresponding to the optical surface configuration of the first optical member;
fabricating a first sub master mold by lining the sub master molding part with a first transparent sub master substrate made of glass, thereby;
molding a second sub master molding part having a plurality of molding surfaces with a negative configuration corresponding to an optical surface configuration of the second optical member by using a transparent fourth hardening resin, from a second master mold having a plurality of molding surfaces with a positive configuration corresponding to the optical surface configuration of the second optical member;
fabricating a second sub master mold by lining the sub master molding part with a second transparent sub master substrate made of glass, thereby;
filling a space between the first sub master mold and the glass substrate with the first hardening resin and hardening the first hardening resin by providing irradiation from a side of the first sub master mold, thereby molding the first optical member, wherein the first hardening resin is composed of an epoxy resin; and
filling a space between the second sub master mold and the glass substrate with the second hardening resin and hardening the second hardening resin by providing irradiation from a side of the second sub master mold, thereby molding the second optical member, wherein the second hardening resin is composed of an epoxy resin.

2. The method of claim 1, wherein, after filling the space between the first sub master and the substrate with the first hardening resin and filling the space between the second sub master and the substrate with the second hardening resin, the first hardening resin and the second hardening resin are provided with irradiation from both the side of the first sub master mold and the side of the second sub master mold simultaneously.

3. The method of claim 1, further comprising: post-curing the first hardening resin and the second hardening resin by heating after the first hardening resin and the second hardening resin have been cured by providing irradiation.

4. The method of claim 3, further comprising: heating the first hardening resin and the second hardening resin before removing the first sub master mold and the second sub master mold from the first hardening resin and the second hardening resin; and heating the first hardening resin and the second hardening resin after removing the first sub master mold and the second sub master mold from the first hardening resin and the second hardening resin.

5. A method for producing a wafer lens in which a first optical member made of a photocurable first hardening resin is provided on one side of a glass substrate, and a second optical member made of a photocurable second hardening resin is provided on the other side of the glass substrate, the method comprising the steps of:
providing a first master mold having a plurality of first molding surfaces with a positive configuration corresponding to an optical surface configuration of the first optical member;
applying a transparent third hardening resin on the plurality of first molding surfaces of the first master mold to form an applied shape;
hardening the applied third hardening resin, thereby forming a first sub master molding part having a plurality of first molding surfaces with a negative configuration corresponding to the optical surface configuration of the first optical member, wherein the third hardening resin is hardened in substantially its applied shape;
fabricating a first sub master mold by lining the sub master molding part with a transparent first sub master substrate made of glass;
providing a second master mold having a plurality of second molding surfaces with a positive configuration corresponding to an optical surface configuration of the second optical member;
applying a transparent fourth hardening resin on the plurality of second molding surfaces of the second master mold to form an applied shape;
hardening the applied fourth hardening resin, thereby forming a second sub master molding part having a plurality of second molding surfaces with a negative configuration corresponding to the optical surface configuration of the second optical member, wherein the fourth hardening resin is hardened in substantially its applied shape;
fabricating a second sub master mold by lining the sub master molding part with a transparent second sub master substrate made of glass;
providing the first hardening resin on the molding surface of the first sub master mold, bringing the one side of the glass substrate into contact with the first hardening resin provided on the first sub master mold, and hardening the first hardening resin by providing irradiation from a side of the first sub master mold, thereby molding the first optical member, wherein the first hardening resin is composed of an epoxy resin;
turning the glass substrate and the first sub master mold upside down while holding the first hardening resin therebetween; and
providing the second hardening resin on the molding surface of the second sub master mold, bringing the other side of the glass substrate into contact with the second hardening resin provided on the second sub master mold, and hardening the second hardening resin by providing irradiation from a side of the second sub master mold, thereby molding the second optical member, wherein the second hardening resin is composed of an epoxy resin.

6. The method of claim 5, wherein the optical surface configuration of the first and second master molds are designed in anticipation of possible curing shrinkages of the first, the second, the third and the fourth hardening resins.

7. The method of claim 5, wherein a difference between a linear expansion coefficient of the resin constituting the first sub master molding part and a linear expansion coefficient of the first sub master substrate is 3×10⁻⁵/K or less.

8. The method of claim 5, wherein a difference between a linear expansion coefficient of the resin constituting the second sub master molding part and a linear expansion coefficient of the second sub master substrate is 3×10⁻⁵/K or less.

9. The method of claim 5, wherein lining the first sub master molding part with the first sub master substrate is conducted using an adhesive after the third hardening resin has been cured, and lining the second sub master molding part with the second sub master substrate is conducted using an adhesive after the fourth hardening resin has been cured.

10. The method of claim 5, wherein lining the first sub master molding part with the first sub master substrate is conducted before the third hardening resin has been cured, and lining the second sub master molding part with the second sub master substrate is conducted before the fourth hardening resin has been cured.

11. The method of claim 5, wherein the third and fourth hardening resins are photocurable resin, and the method further comprises: curing the third and fourth hardening resins by providing irradiation.

12. The method of claim 11, further comprising: post-curing the third and fourth hardening resins by heating after the third and fourth hardening resins have been cured by providing irradiation.

13. The method of claim 5, further comprising: post-curing the first hardening resin by heating after the first hardening resin has been cured by providing irradiation and post-curing the second hardening resin by heating after the second hardening resin has been cured by providing irradiation.

14. The method of claim 5, further comprising: heating the first hardening resin before removing the sub master mold from the first hardening resin; heating the second hardening resin before moving the sub master mold from the second hardening resin; and heating the first and second hardening resins after removing the first and second sub master molds from the first and second hardening resins.

15. The method of claim 5, wherein the first optical member is by providing irradiation from the side of the first sub master mold and from a side of the substrate, and second optical member is molded by providing irradiation from the side of the second sub master mold and from a side of the substrate.

16. The method of claim 5, wherein the first optical member comprises a plurality of lens parts arranged in an array, and the second optical member comprises a plurality of lens parts arranged in an array.
